(19) United States
(12) Patent Application Publication
(10) Pub. No.: US 2008/0294594 A1
(43) Pub. Date: Nov. 27, 2008

(54) AUDIT TRAIL MANAGEMENT METHOD, SYSTEM AND PROCESSING PROGRAM

(76) Inventors: Hiroshi Hamaguchi, Yokohama (JP); Mitsuru Nishimura, Kawasaki (JP); Mai Asai, Tokyo (JP); Keiji Fujii, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/039,401

(22) Filed: Feb. 28, 2008

(30) Foreign Application Priority Data
May 23, 2007 (JP) 2007-136127

(51) Int. Cl. G06F 7/00; G06F 17/30

(52) U.S. Cl. 707/1; 707/E17.005

(57) ABSTRACT

When an access is made to a database from an application in accordance with a request of a user in an application server, thread information and request identification are acquired. The two kinds of information are then delivered to a database connector and are outputted to the database with information outputted by an output function of the database. A request identification information management function holds the request identification information and an audit trail information management function holds the thread information. These kinds of information are collected by an audit trail DB cooperative function and are delivered to the database connector.

### INCORPORATION BY REFERENCE

The present application claims priority from Japanese application JP2007-136127 filed on May 23, 2007, the content of which is hereby incorporated by reference into this application.

### BACKGROUND OF THE INVENTION

This invention relates to an audit trail management technology for recording an audit trail that makes it easy to trace accesses made by users in an information processing apparatus.

The term “audit trail” hereby used means a record that clarifies the accesses made by the users of the information processing apparatus and execution processes of programs and certifies safety and reliability of business processes including the information processing apparatus.

A system that outputs information of an account accessed by a database (a technology disclosed in JP-A-2006-048562, for example) and a system that collects operation logs to a WEB browser and logs of an application server and a database server and specifies the user by executing a trace processing of the logs (a technology disclosed in JP-A-2007-048266, for example) have been employed in the past as the technology for acquiring the audit trail.

### SUMMARY OF THE INVENTION

Each of the application servers (103), (114) and (124) for operating a business program that are shown in FIGS. 2 and 3 has a database connector (105), (115) and (125) for communicating with a database management system DBMS that manages a database. The database connector accomplishes access to the database (107), (117) and (127) and pools and manages such a connection. In the prior art technology disclosed in JP-A-2006-048562, therefore, account information outputted to the database (107) is information of the connection managed by the application server (103) such as “DB user” when the application (program) (104) executed by the application server (103) on the basis of the request sent from the instruction of users (101) and (102) makes access to the database (107) from the DBMS (106) as shown in FIG. 2. In other words, this prior art technology involves the problem that information for specifying the user of the information processing apparatus cannot be recorded.

The prior art technology described in JP-A-2007-048266 acquires history of each processing unit in the information processing apparatus and specifies a user to each processing unit by executing the trace processing on the basis of the access date to the database (107), (117), (127) and input information. It is necessary in this instance to acquire the history in each processing unit, to further acquire information of the user and to judge which user is a corresponding user. In the trace processing of the history, the date and time of accesses is not always coincident owing to variance of the time of a timer in each processing unit and a processing such as fuzzy retrieval becomes necessary from time to time. Therefore, there remains the problem that reliability as audit information cannot be insured sufficiently.

When the application (114) executed on the application server (113) makes access to the database (117) from the DBMS (116) through the database connector (115) in response to the request raised by the users (111) and (112) of the information processing apparatus as shown in FIG. 3, for example, the invention aims at providing a function of outputting information for specifying the user such as “APuser01” and “APuser02”. When the application (114) calls the application (124) on other application server (123) in response to the request raised by the user (112), too, it is another object of the invention to provide a function of outputting information for specifying the user such as “APuser02”.

To accomplish the objects described above, the invention accomplishes the output function of audit trail information by employing the following structure.

When access is made from an application to a database by a request of a user, request identification information is acquired on the basis of a thread ID of the application and these kinds of information are outputted to the database. In the application server, an audit trail information management function holds user identification information in association with the thread ID. The user identification information is set from the application. When the application makes access to the database, the user identification information and the request identification information are acquired on the basis of the thread ID. This information is outputted to the database, too. The user identification information is acquired at the time of authentication and is set to the audit trail information management function. In this way, the necessity for setting from the application can be eliminated.

In remote communication, the user identification information as well as processing information of a method is transmitted and arbitrary information set from the application such as the name and position of a user can be acquired in addition to the user identification information by the audit trail management function. These kinds of information are also outputted to the database.

Since the user information that the application program identifies can be contained in the audit trail, the invention can accomplish the audit trail of the user information that the application program identifies.

Other objects, features and advantages of the invention will become apparent from the following description of the embodiments of the invention taken in conjunction with the accompanying drawings.

### BRIEF DESCRIPTION OF THE DRAWINGS

FIG. 1 shows an overall structure of a system.

FIG. 2 shows the problems of the prior art.

FIG. 3 shows the principle of the present invention.

FIG. 4 shows a structure of an application server (303).

FIG. 5 shows a structure of a database server (312).

FIG. 6 shows an example of thread information (404).

FIG. 7 shows an example of request identification information (405).

FIG. 8-1 shows an example of database access information (406).

FIG. 8-2 shows an example of audit trail information (505).

FIG. 9 shows a schematic processing flow.

FIG. 10 shows a detailed flow for setting (605) of request identification information and thread information.

FIG. 11 shows a detailed flow for setting (605) of request identification information and thread information.

FIG. 12 shows a flow of data of thread information and request identification information.

FIG. 13 shows a processing flow when a database access request exists in a processing (604) of an application.

FIG. 14 shows an example of an output of audit trail information in a database access.

FIG. 15 shows a processing flow of remote communication that utilizes RMI-IIOP.

### DESCRIPTION OF THE EMBODIMENTS

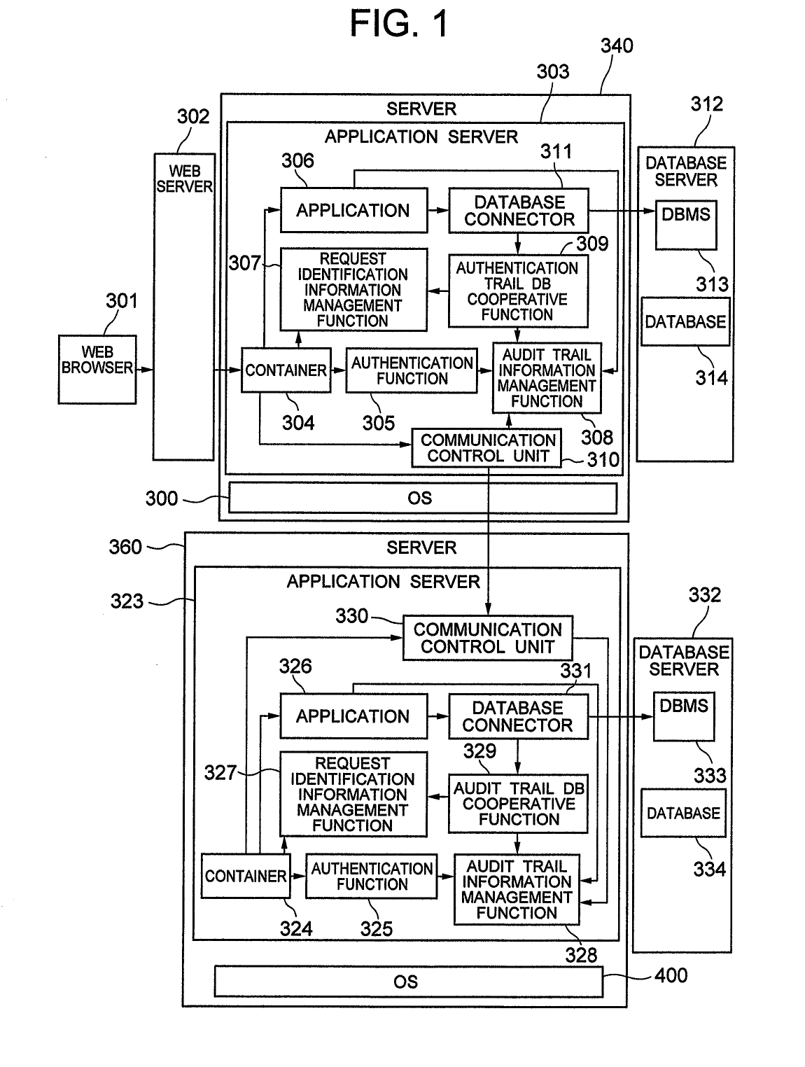

FIG. 1 shows an overall structure of an embodiment of the invention. This structure includes a WEB browser (301), a WEB server (302), servers (340) and (360) and database servers (312) and (332).

The server (340) is constituted by an application server (303) as an execution base of each processing unit and an OS (300) for managing an information processing unit as a whole.

The processing unit on the application server (303) includes a container (304) for accepting an operation by a user, an authentication function (305) for authenticating the user, an application (306) for executing a logic corresponding to the operation, a request identification information management function (307) for managing request identification information, an audit trail cooperative function (audit trail information management function (308) for managing thread information, and an audit trail DB cooperative function (309) for delivering request information and thread information to a database connector (311)), a communication control unit (310) for executing communication with other application server (323) and a database connector (311) for managing accesses to the database.

Incidentally, the authentication function (305) and the application (306) are executed on the container (304) and the audit trail DB cooperative function (309) is executed on the database connector (311).

The database server (312) includes a DBMS (313) for executing operation for the database (314) and a database (314) for storing data.

Remote call is executed by the communication control unit (310) when the application (326) on other application server (323) is called by the execution of the application (program) (306) on the application server (303).

The server (340) as the destination of the remote call includes an application server (323) as the execution basis of each processing unit and an OS (400) for controlling the information processing apparatus as a whole.

The processing unit on the application server (323) includes a container (324), an authentication function (325), an application (326), a request identification information management function (327), an audit trail cooperative function (audit trail information management function (328) and an audit trail DB cooperative function (329)), a communication control unit (330) and a database connector (331).

Incidentally, the authentication function (325) and the application (326) are executed on the container (324) and the audit trail DB cooperative function (329) is executed on the database connector (331).

The database server (332) includes DBMS (333) and a database (334).

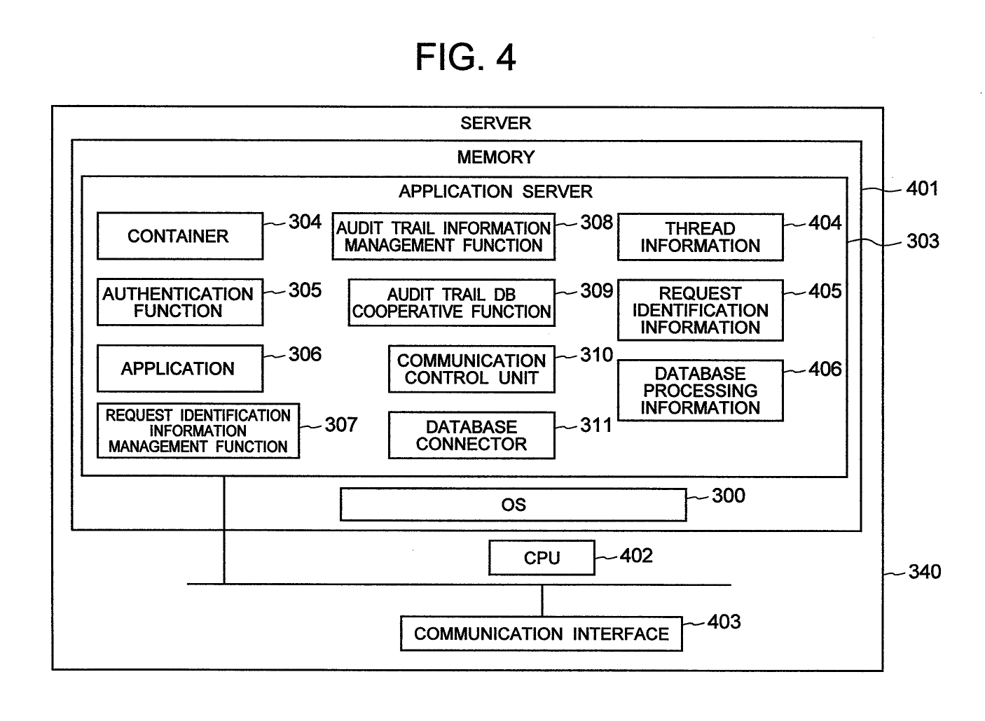

FIG. 4 shows a detail structure of the server (340). The server (340) includes a memory (401), a CPU (402) and a communication interface (403).

The application server (303) and the OS (300) are stored on the memory (401). Stored also on the memory (401) are the container (304), the authentication function (305), the application (306), the request identification information management function (307), the audit trail cooperative function (audit trail information management function (308) and audit trail DB cooperative function (309)), the communication control unit (310), the database connector (311), thread information (404) associating the thread ID, the user identification information and arbitrary information with one another, request identification information (405) associating the IP address of the application, an process ID, a communication number and thread ID with one another and database processing information (406) handed over by the database connector (311) to the DBMS (313) at the time of the database access. This structure also holds true of the server (360).

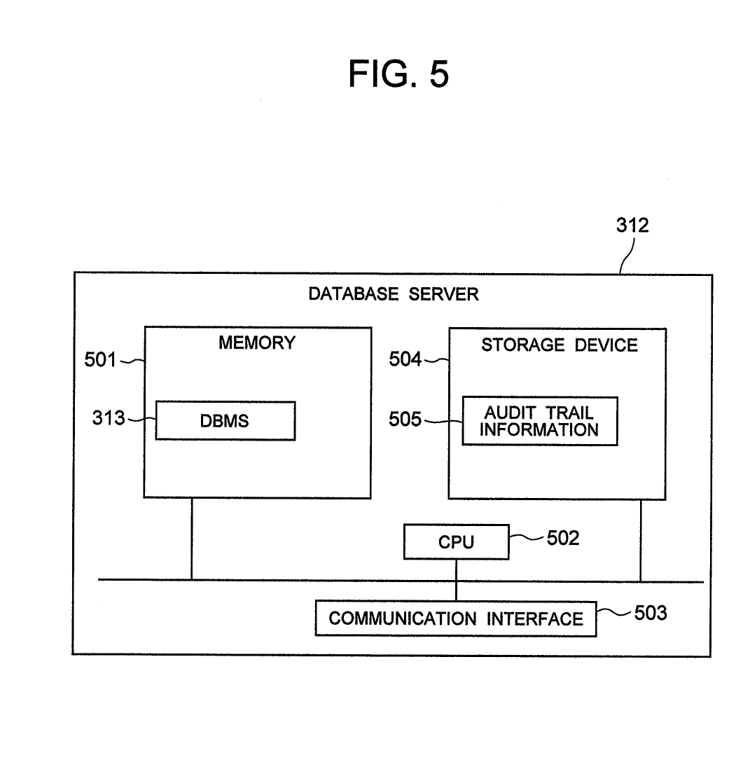

FIG. 5 shows a detailed structure of the database server (312). The database server (312) includes a memory (501), a CPU (502), a communication interface (503) and a storage device (504).

The DBMS (313) is stored on the memory (501) and the audit trail information (505) as the information for easily tracing the audit trail is stored in the storage device (504). Incidentally, the database server (332) has the same structure.

Referring to FIGS. 4 and 5, each processing unit has a work space and executes temporal storage of information and an operation processing by using this work space.

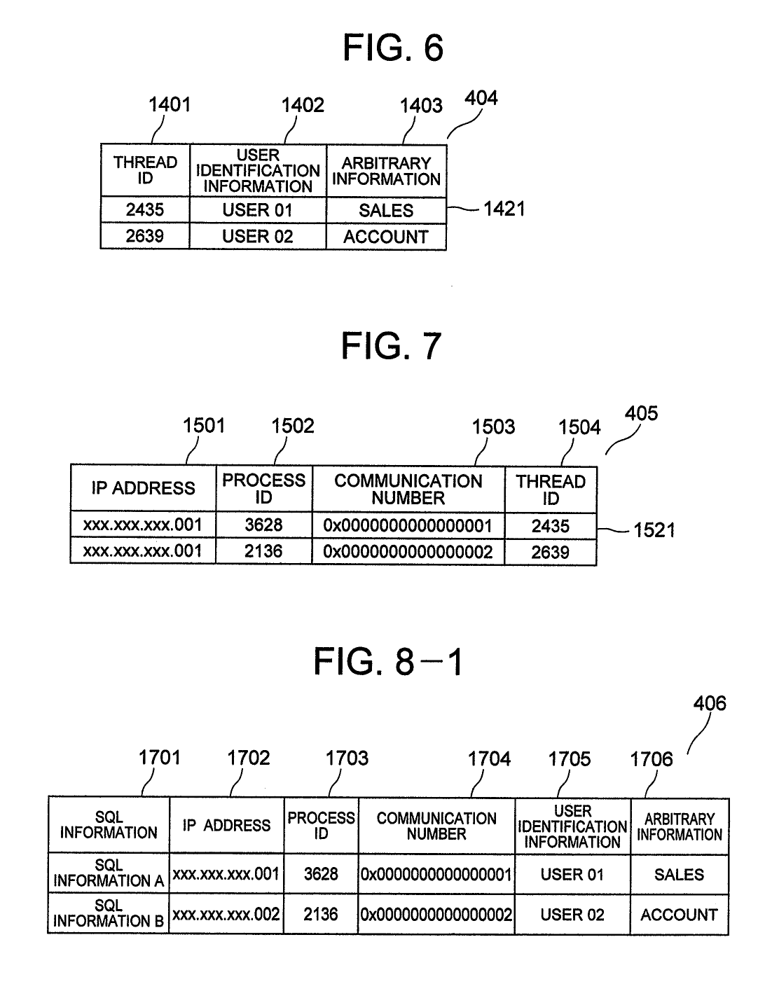

FIG. 6 shows a data structure of thread information (404) for associating a user and a thread ID of the thread for processing the request of the user. The thread information (404) includes a thread ID (1401) capable of primarily specifying the thread information (404), user identification information (1402) for representing the user such as the user ID and arbitrary information (1403) that can be utilized for specifying the user such as a position or name of the user.

FIG. 7 shows the combination of information capable of primarily specifying the request from the user and a data structure (405) of the request identification information (405) linking the thread ID of the thread for executing the request. The request identification information (405) includes an IP address (1501) of an application, a process ID (1502) of a process, a communication number (1503) of the process and a thread ID (1504).

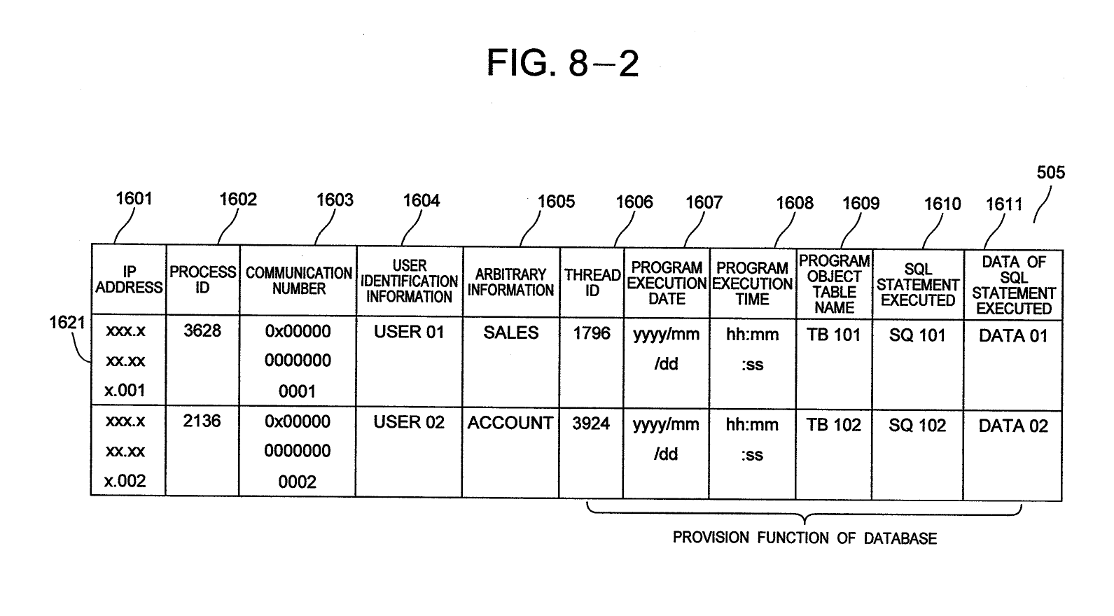

FIG. 8-1 shows a data structure of database access information (406) delivered by the database connector to the DBMS when a processing request for the database is issued during the execution of an application. The database access information (406) includes SQL information(1701) representing the processing content for the database, an IP address (1702) of the application, a process ID (1703), a communication number (1704), user identification information (1705) and arbitrary information (1706). The invention is directed to the DBMS and the DB that can receive SQL information (1701) and load information such as the database access information (406).

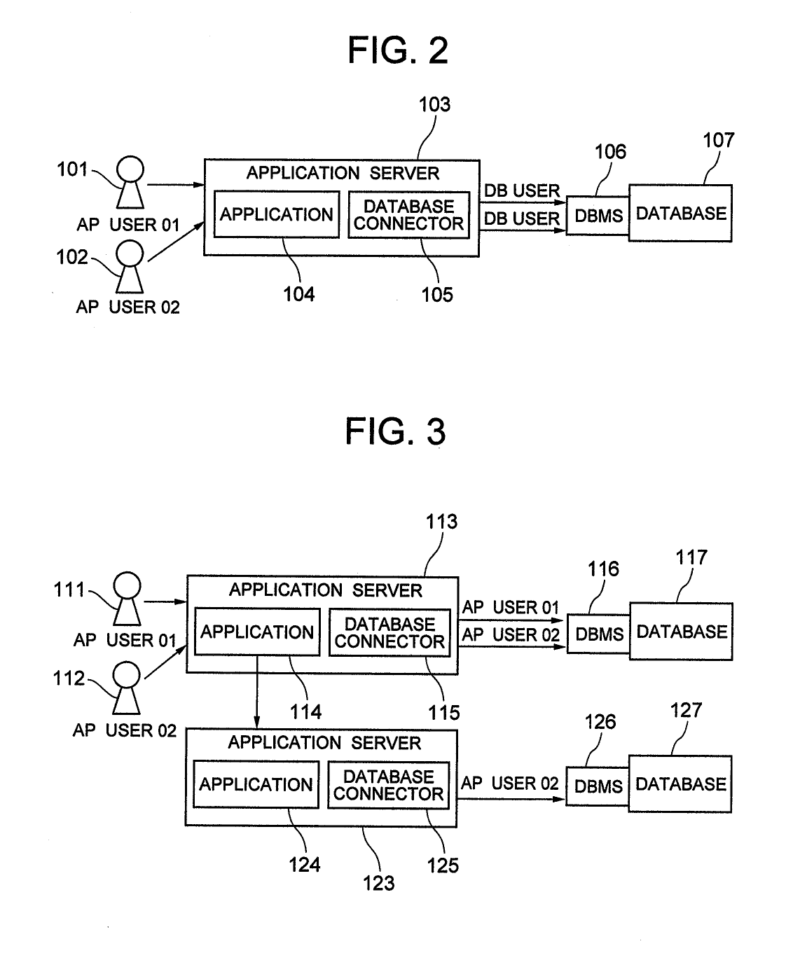

FIG. 8-2 shows the data structure of the audit trail information (505) for linking the combination of information capable of primarily specifying the request from the user and the history of the access from the user to the database. The audit trail information (505) includes an IP address (1601) of an application, a process ID (1602), a communication number (1603), user identification information (1604), arbitrary information (1605), a thread ID (1606) acquired by a provision function of a database, a program execution date (1607),a program execution time (1608), a program object table name (1609), an SQL statement (1610) executed and data (1611) of the SQL statement executed.

The audit trail of accessing to the database by utilizing the application can be confirmed from this audit trail information (505). In the record (1621) of the audit trail information (505), for example, it can be understood that it is the user of arbitrary information “sales” having the user identification information “user01” who executes SQL with its data “sq101”/“data01” at the execution time “hh:mm:ss” of the year-month-day “yyyy/mm/dd” on the table “tb101” by the thread ID “1796” in the database access processing. In the application executed in this access, the IP address is “xxx.xxx.xxx.001”, the process ID is “3628” and the communication number is “0x0000000000000001”, and the user identification information and the arbitrary information can be specified from these values. The same effect can be obtained by using the thread ID in place of the communication number.

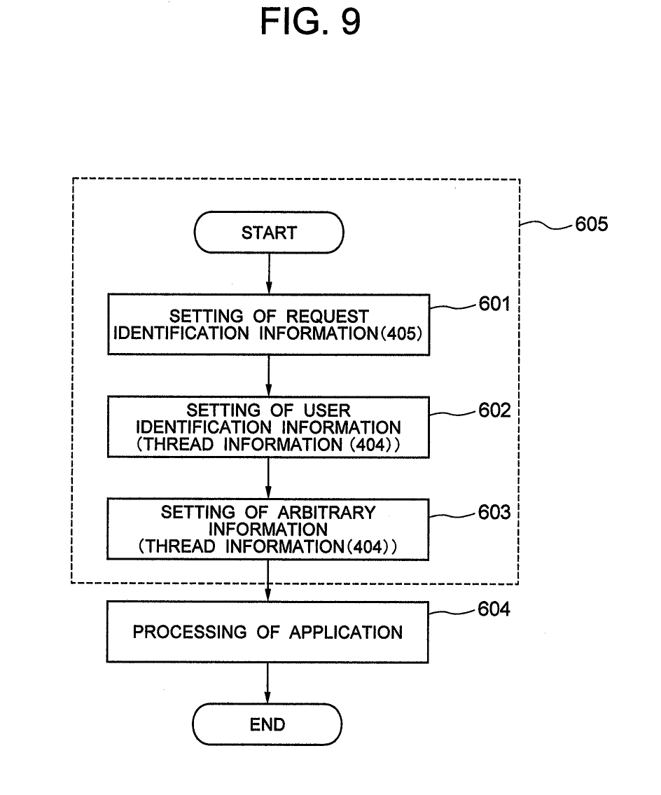

FIG. 9 shows the outline of the flow of this embodiment. After the user starts operation to the application, setting (601) of the request identification information is first made. Setting (602) of the user identification information constituting the thread information and setting (603) of the arbitrary information are further made and the processing (604) of the application is executed.

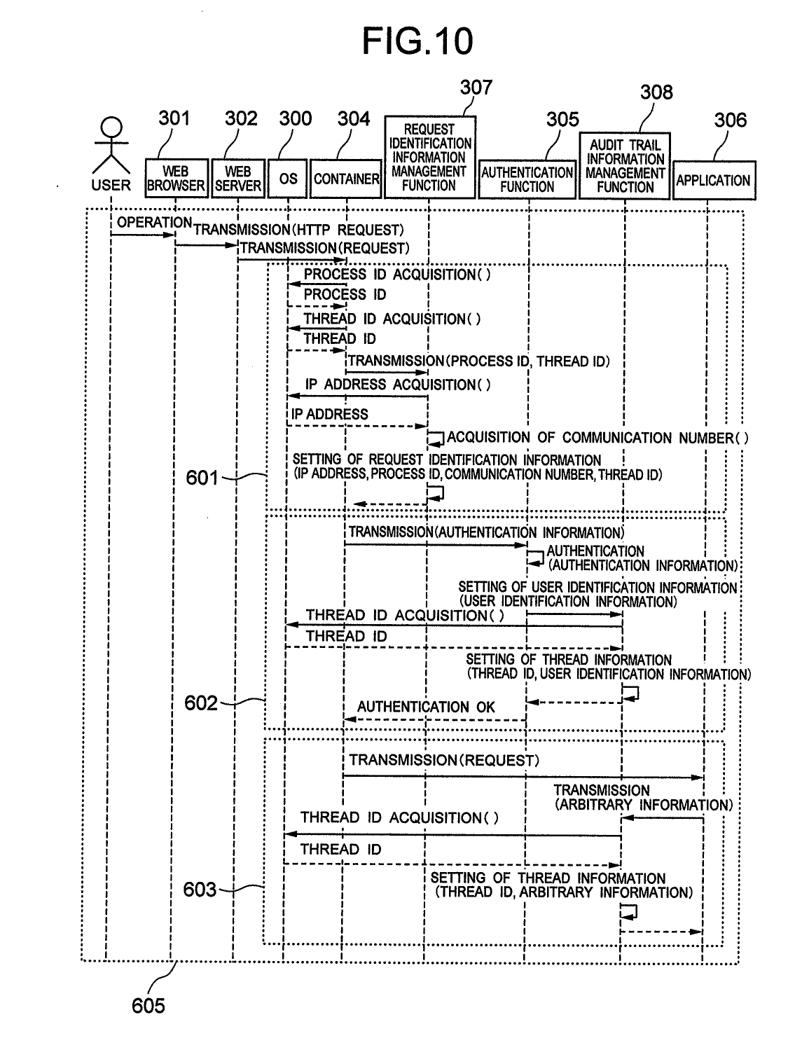

FIG. 10 shows a detailed flow of broken line portions (605) in FIG. 9. This represents the flow until the operation request of the user reaches the application (306) when the user utilizes the application. LDAP authentication will be described as authentication by way of example. When the user conducts an operation to the WEB browser (301), the WEB browser puts the operation request inputted by the user to the WEB browser (301) and the user identification information to the HTTP request and transmits them to the WEB server (302). Next, the WEB server (302) transmits the request including the operation request of the user and the user identification information to the container (304).

The OS (300) returns the process ID and the thread ID to the container (304) in response to the acquisition request of the process ID and the thread ID raised by the container (304) to the OS (300). The container (304) transmits the acquired process ID and the acquired thread ID to the request identification information management function (307). Next, the OS (300) returns the IP address to the request identification information management function (307) in response to the acquisition request of the IP address of the application server (303), that the request identification information management function (307) outputs to the OS (300). The request identification information management function (307) then acquires the communication number it holds by itself. Furthermore, the request identification information function (307) sets the process ID acquired, the IP address and the communication number in association with the thread ID to the request identification information (405).

After this processing, the container (304) transmits authentication information including user identification information to the authentication function (305). The authentication function (305) executes authentication by using the authentication information received. At this time, the authentication information is transmitted to the LDAP server to inquire whether or not the user is authorized to utilize the application (306). The authentication function (305) receives the judgment result after the judgment by the LDAP server. Next, the OS (300) returns the thread ID to the audit trail information management function (308) in response to the thread ID acquisition request outputted by the authentication trail information management function (308) to the OS (300). Furthermore, the audit trail information management function (308) sets the thread ID and the user identification information in association with each other to the thread information (404).

When the authentication result is OK, the container (304) transmits a request to the application (306). Next, the application (306) transmits arbitrary information to the audit trail information management function (308). Next, the OS (300) returns the thread ID to the audit trail information management function (308) in response to the thread ID acquisition request outputted by the authentication trail information management function (308) to the OS (300). Furthermore, the audit trail information management function (308) sets the thread ID and the arbitrary information in association with each other to the thread information (404).

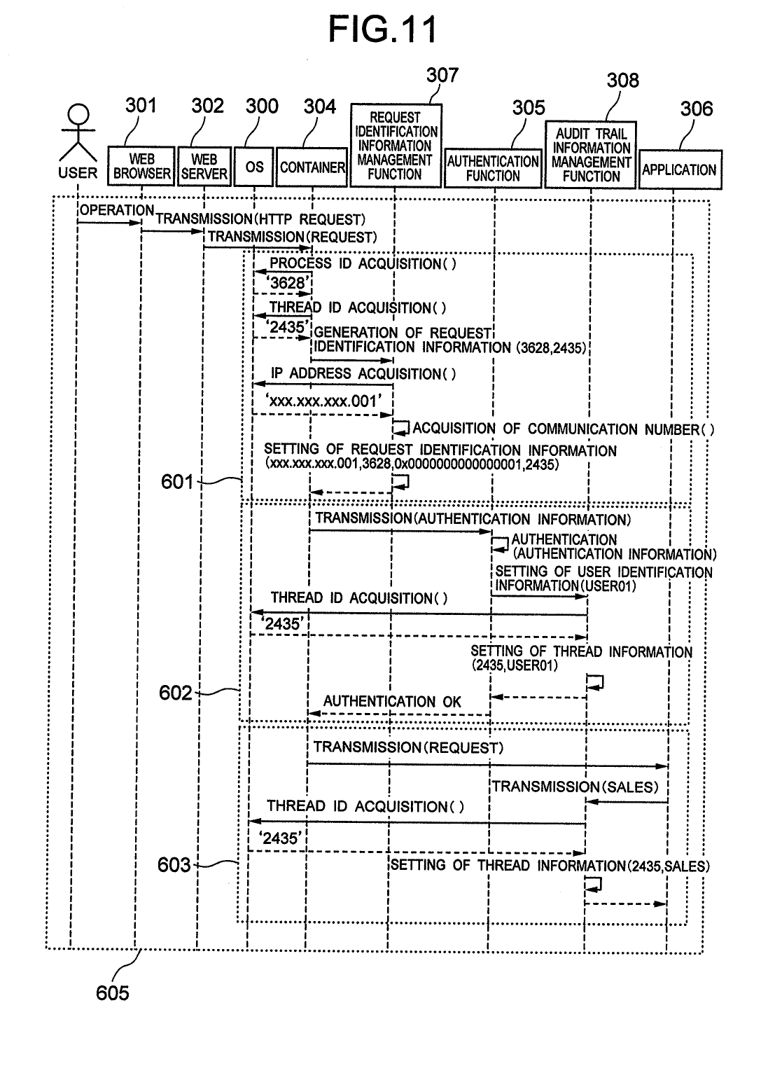

FIG. 11 shows an example of a detailed flow of broken line portions (605) in FIG. 9. This represents the flow until the value of the record (1421) shown in FIG. 6 and the value of the record (1521) shown in FIG. 7 are set.

When the user conducts an operation to the WEB browser (301), the WEB browser puts the operation request inputted by the user to the WEB browser (301) and the user identification information “user01” to the HTTP request and transmits them to the WEB server (302). Next, the WEB server (302) transmits the request including the operation request of the user and the user identification information “user01” to the container (304).

The OS (300) returns the process ID “3628” and the thread ID “2435” to the container (304) in response to the acquisition request of the process ID and the thread ID sent by the container (304) to the OS (300). The container (304) transmits the process ID “3628” and the thread ID “2435” acquired to the request identification information management function (307). Next, the OS (300) returns the IP address “xxx.xxx.xxx.001” to the request identification information management function (307) in response to the acquisition request of the IP address of the application server (303) that the request identification information management function (307) outputs to the OS (300). The request identification information management function (307) then acquires the communication number “0x0000000000000001” it holds by itself. Furthermore, the request identification information function (307) sets the process ID “3628”, the IP address “xxx.xxx.xxx.001”, the communication number “0x0000000000000001” and the thread ID “2435” acquired, in association with one another to the request identification information (405).

After this processing, the container (304) transmits authentication information containing user identification information “user01” to the authentication function (305). The authentication function (305) executes authentication by using the authentication information received. At this time, the authentication information is transmitted to the LDAP server to inquire whether or not the user is authorized to utilize the application (306). The authentication function (305) receives the judgment result after the judgment by the LDAP server. Next, the OS (300) returns the thread ID “2435” to the audit trail information management function (308) in response to the thread ID acquisition request outputted by the authentication trail information management function (308) to the OS (300). Furthermore, the audit trail information management function (308) sets the thread ID “2435” and the user identification information “user01” in association with each other to the thread information (404).

When the authentication result proves OK, the container (304) transmits a request to the application (306). Next, the application (306) transmits arbitrary information “sale” to the audit trail information management function (308). Next, the OS (300) returns the thread ID “2435” to the audit trail information management function (308) in response to the thread ID acquisition request outputted by the authentication trail information management function (308) to the OS (300). Furthermore, the audit trail information management function (308) sets the thread ID “2435” and the arbitrary information “sales” in association with each other to the thread information (404).

In the processing flow shown in FIGS. 10 and 11, the thread ID is unique. Therefore, since the request identification information (405) held by the request identification information management function (307) and the thread information (404) held by the audit trail information management function (308) can be linked with each other through the thread ID, the audit trail information (505) can be generated from these kinds of information.

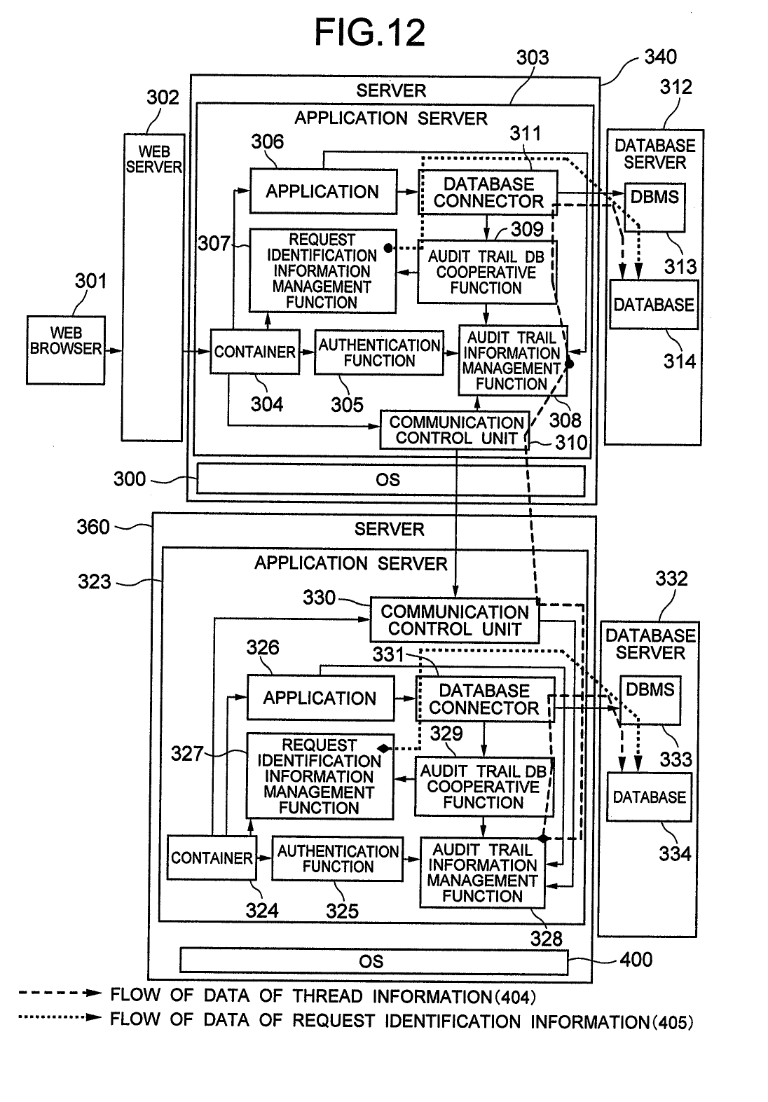

FIG. 12 shows the flow of data until the thread information (404) and the request identification information (405) generated as in FIGS. 10 and 11 are outputted to the database. When an access request is issued from the application (306) to the database (314), the audit trail DB cooperative function (309) acquires the request identification information (405) from the request identification information management function (307) and the thread information (404) from the audit trail information management function (308). The audit trail DB cooperative function (309) delivers the request identification information (405) and the thread information (404) to the database connector (311). The database connector (311) puts the request identification information (405) and the thread information (404) into the processing information of the database and delivers them to the DBMS (333). The DBMS (313) executes the processing for the database (314) and outputs the processing result with the output information provided by the output function to the database (314).

Similarly, when the application (326) on other application server (323) is called by remote communication in FIG. 12, the thread information (404) is transmitted to the communication control unit (330) of the call destination to transmit the user identification information and the arbitrary information. Furthermore, the communication control unit (330) delivers the thread information (404) received to the audit trail information management function (328) of the call destination. In remote communication, the request identification information (405) is not transmitted to the call destination. Instead, the IP address of the application (326) of the transmission destination is generated afresh and the request identification information (405) is generated afresh, too.

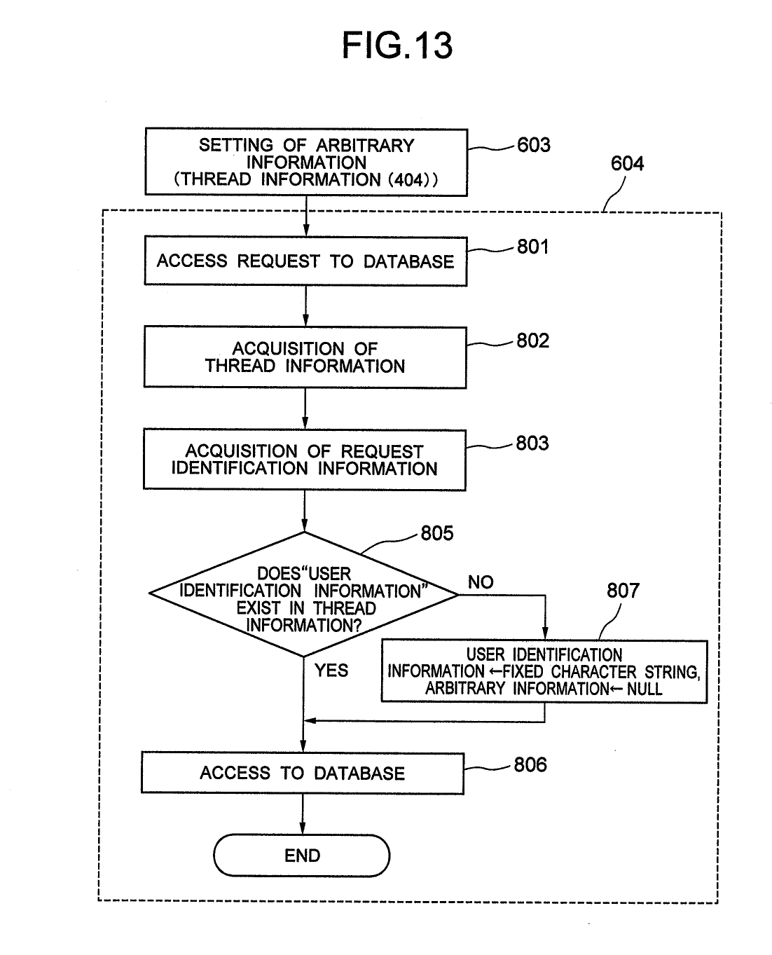

FIG. 13 shows the processing flow when a database access request exists in the processing (604) of the application. First, when the access request (801) is issued from the application (306) to the database (314), the audit trail information management function (308) acquires (802) the thread information and further acquires (803) the request identification information (404) corresponding to that thread information (404). Next, whether or not the user identification information exists in the thread information (404) managed by the audit trail information management function (308) is judged (805). When the user identification information is set, access to the database is executed and the audit trail information (505) is outputted (806) to the database. When the user identification information does not exist in the thread information (404), a fixed character string and “NULL” are set to the user identification information and to the arbitrary information (807), respectively, and the audit trail information is outputted to the database (806). When the user identification information does not exist and when a processing not specifying the user such as a periodical batch processing is made, for example, the fixed character string is outputted to clearly distinguish the processing.

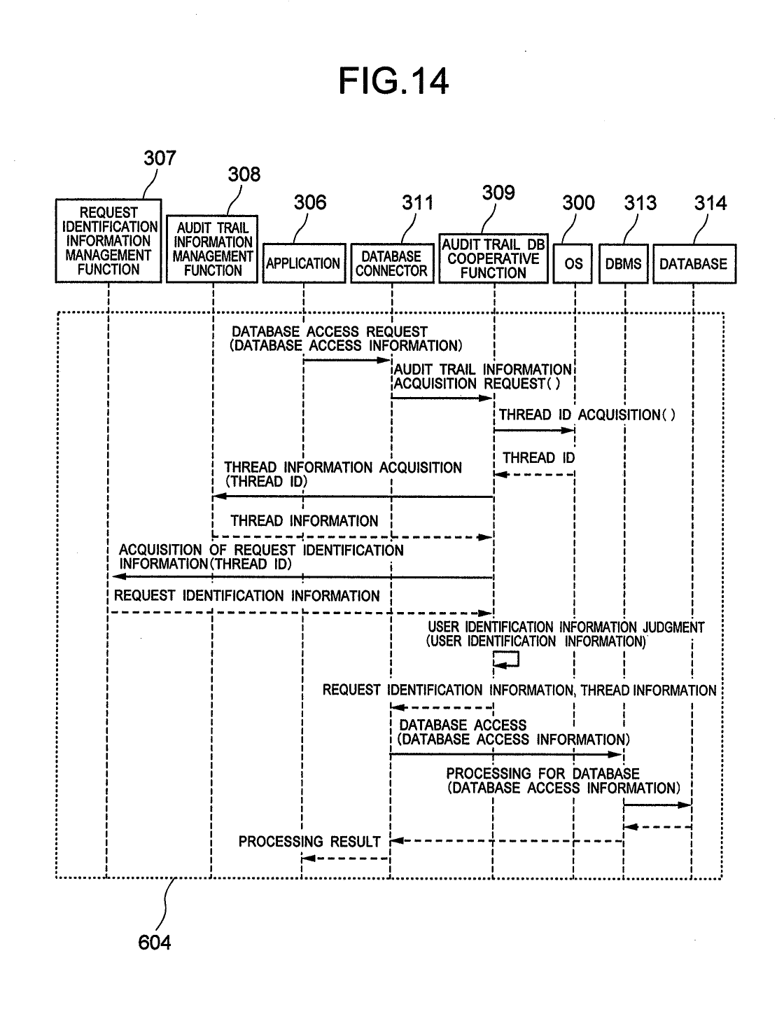

FIG. 14 shows the processing flow for the output of the audit trail information in the database access. The flowchart represents the flow until the access is made to the database (314) in response to the processing request of the application (306). This processing flow corresponds to the processing flow of the access request (801) to the database, acquisition of the thread information (802), acquisition of the request identification information (803), judgment of the thread information (805) and access to the database (806).

When the application (306) issues the access request to the database for the database connector (311) with the database access information (406) containing the request of the processing, the database connector (311) issues the acquisition request of the audit trail information to the audit trail cooperative function (309).

Next, the OS (300) returns the thread ID to the audit trail DB cooperative function (309) in response to the thread ID acquisition request issued by the audit trail DB cooperative function (309) to the OS (300). Next, the audit trail information management function (308) returns the thread information (404) to the audit trail DB cooperative function (309) in response to the acquisition request of the thread information (404) issued by the audit trail DB cooperative function (309) to the audit trail information management function (308).

Furthermore, the audit trail DB cooperative function (309) returns the request identification information (405) to the audit trail DB cooperative function (309) in response to the acquisition request of the request identification information (405) issued by the audit trail DB cooperative function (309) to the request identification information management function (307).

The audit trail DB cooperative function (309) judges whether or not the user information of the thread information (404) is set, and returns the request identification information (405) and the thread information (404) to the database connector (311) when the user information is set.

The database connector (311) issues the access request of the database to the DBMS (313) after including the request identification information (406) and the thread information (404) in the database access information (406) requested from the application. Next, the DBMS (313) executes the processing for the database (314) and outputs the request identification information (406) and the thread information (404) each included in the database access information (406) together with the output information of the function provided by the database (314) as the audit trail information (505).

The audit trail information (505) can be outputted in this way to the database (314).

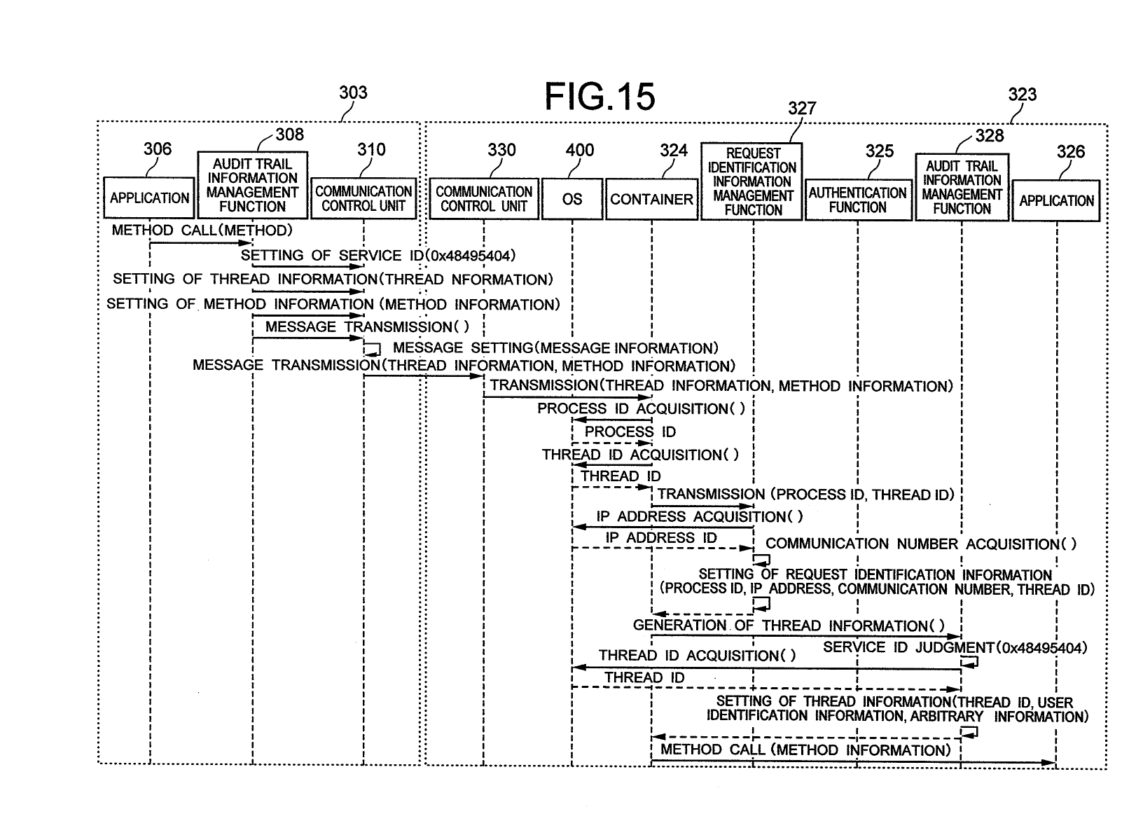

FIG. 15 shows a processing flow of remote communication as an example of the remote communication shown in FIG. 12 when RMI-IIOP is utilized. The chart represents the flow until the thread information (404) is transmitted to the audit trail information management function (328) on the call destination application server (323) when the processing of the call destination application (326) is called from the call origination application (306) through the communication control units (310) and (330). When the application (306) calls the application (326) on other application server (323) by remote communication, the application (306) executes method call to the audit trail information management function (308). Next, the audit trail information management function (308) requests the communication control unit (310) to set the service ID “0x48495404”, thread information (404) and method information and to transmit the message. The communication control unit (310) sets the message information including the service ID “0x48495404”, thread information (404) and method information to the GIOP message and transmits the GIOP message to the call destination communication control unit (330).

In the call destination application server (323), the communication control unit (330) first transmits the thread information (404) and the method information received from the communication control unit (310) to the container (324). Next, the OS (400) returns the process ID and the thread ID to the container (324) in response to the acquisition request of the process ID and the thread ID issued by the container (324) to the OS (400). The container (324) transmits the acquired process ID and thread ID to the request identification information management function (327). The OS (400) then returns the IP address to the request identification information management function (327) in response to the acquisition request of the IP address issued by the request identification information management function (327) to the OS (400). The request identification information management function (327) acquires the communication number held by the request identification information management function (327) itself. Furthermore, the request identification information management function (327) sets the acquired process ID, IP address, communication number and thread ID in association with one another to the request identification information (405).

After this processing, the container (324) requests the audit trail information management function (328) to generate the thread information. Next, the audit trail information management function (328) makes the service ID judgment. When its value is “0x48495404”, the audit trail information management function (328) issues the acquisition request of the thread ID for the OS (400) and the OS (400) returns the thread ID to the audit trail information management function (328). Furthermore, the audit trail information management function (328) sets the thread ID, the user identification information and the arbitrary information in association with one another to the thread information (404). The container (324) then transmits the method information to the application (326) and the subsequent process is performed by the application.

As transmission of the thread information (404) is made in this way in the remote communication between the application servers, information for specifying the user can be taken over by the application server requiring it in a system having a plurality of application servers (323).

It should be further understood by those skilled in the art that although the foregoing description has been made on embodiments of the invention, the invention is not limited thereto and various changes and modifications may be made without departing from the spirit of the invention and the scope of the appended claims.

1. An audit trail management method in an information processing apparatus, having a storage device, for accessing to a database management apparatus which manages a database and manages history of accesses to said database as an audit trail, comprising the steps of:
analyzing a request including user identification information of a user sent from said user in response to input of said request, and acquiring said user identification information;
executing a program for processing said request on the basis of said analysis result;
acquiring program identification information of said program executed and storing said program identification information as database access information in said storage device in association with said user identification information; and
generating an inquiry request including said database access information when an access is made to said database to transmit said inquiry request to said database management apparatus managing said database.

2. An audit trail management method according to claim 1, further comprising the step of: managing said user identification information set by the execution of said program and outputting said user identification information with request identification information to said database.

3. An audit trail management method according to claim 2, further comprising the steps of: authenticating a user, and setting said user identification information acquired at the time of authentication of the user to said audit trail information management information.

4. An audit trail management method according to claim 2, wherein, at the time of call of other process or other thread in said program, said user identification information is transmitted to the process or thread of the call destination by embedding thread information including said user identification information in a message.

5. An audit trail management method according to claim 2, further comprising the step of: managing arbitrary information set by a user with said user identification information and outputting the information in the database to facilitate reference of outputted information.

6. An information processing apparatus, having a storage device, for accessing to a database management apparatus which manages a database and manages history of accesses to said database as an audit trail, comprising:
means for analyzing a request including user identification information of a user sent from said user in response to input of said request, and acquiring said user identification information;
means for executing a program for processing said request on the basis of said analysis result;
means for acquiring program identification information of said program executed and storing said program identification information in association with said user identification information as database access information in said storage device; and
means for generating an inquiry request including said database access information to send it to said database management apparatus which manages said database when an access is made to said database.

7. A program storage device readable by a machine, tangibly embodying a program of instructions executable by the machine to perform method steps for managing an audit trail in an information processing apparatus, having a storage device, for accessing to a database management apparatus which manages a database and manages history of accesses to said database as an audit trail, comprising the steps of:
analyzing a request including user identification information of a user sent from said user in response to input of said request, and acquiring said user identification information;
executing a program for processing said request on the basis of said analysis result;
acquiring program identification information of said program executed and storing said program identification information in association with said user identification information as database access information in said storage device; and
generating an inquiry request including said database access information to send it to said database management apparatus which manages said database when an access is made to said database.
